(19) United States
(12) Patent Application Publication
(10) Pub. No.: US 2024/0007613 A1
(43) Pub. Date: Jan. 4, 2024

(54) Camera Rotation Correction

(71) Applicant: Apple Inc., Cupertino, CA (US)

(72) Inventors: Kartthik Kumarasamy, Cupertino, CA (US); Angelo M. Alaimo, San Jose, CA (US)

(21) Appl. No.: 17/810,083

(22) Filed: Jun. 30, 2022

(51) Int. Cl. H04N 17/00; H04N 5/232; G06T 7/80; G01B 7/30; G01D 5/14; G01D 5/16

(52) U.S. Cl. CPC H04N 17/002; H04N 5/23299; G06T 7/80; G01B 7/30; G01D 5/145; G01D 5/16; G06T 2207/30244

(57) ABSTRACT

Devices, methods, and non-transitory computer readable media are disclosed herein to correct for unwanted rotation in an embedded camera module of an electronic device during field use. Various rotation calibration techniques are disclosed herein, including: a reference pixel pattern-based rotation calibration process; a magnetic field sensor-based rotation calibration process; and a gimbal lock-based rotation calibration process. In some embodiments, an initial rotation calibration angle for the camera module may be obtained during factory calibration and used by the electronic device's image signal processing (ISP) pipeline, so that all captured images are automatically rotation-corrected to compensate for any such rotation measured during factory calibration. In some embodiments, a rotation correction operation may be triggered in response to the electronic device detecting a reliability event (e.g., shock, fall, repair) during field use, which rotation correction operation may be used to update or overwrite the initial rotation calibration angle for the camera module.

### TECHNICAL FIELD

This disclosure relates generally to the field of digital camera calibration and correction. More particularly, but not by way of limitation, it relates to techniques for performing camera rotation correction operations during field usage.

### BACKGROUND

When a camera module is installed or embedded in another electronic device (e.g., in a desktop computer, tablet, mobile phone, or the like) at manufacturing time, it may be subject to various assembly tolerances, which may, in turn, skew or rotate the camera's position relative to the electronic device. These errors in the position of the camera module caused during the assembly process may then show up as tilt and/or rotation in images captured by the camera module in the final assembled electronic device product.

During one user study, it was found that a human-detectable limit for perceiving rotation in a camera module is approximately 0.630. In other words, rotations of 0.630 or more (e.g., in either the clockwise or counterclockwise direction) in a camera module are perceptible to a human viewer of images captured by such a camera module. In the event that the assembly tolerance for rotation of the camera module in the final assembled electronic device is not below this human-detectable limit (e.g., if rotations of up to 20 are permitted during assembly) then, without a method to correct for such unwanted camera module rotation, customers may complain that images captured by the camera module appear rotated or skewed.

Moreover, even if an image signal processing pipeline of the electronic device is initially calibrated and corrected for camera module rotation at manufacture time, the device may be subject to additional reliability events, e.g., a significant shock, drop, or repair, etc., during in-field usage, which may further shift the camera module's rotation into the aforementioned human-detectable region.

In order to prevent unwanted camera module rotation from appearing as undesirable rotation or skewing in processed images captured by such camera modules, it would be beneficial to have solutions that help to calibrate out both the system-assembled rotation error, as well as rotation error caused during in-field usage, e.g., rotation error that may be caused by the camera module being subjected to reliability events in the field. By correcting such rotation error back as closely as possible to zero degrees, the electronic device may thus be able to keep the camera module's rotation below the human-detectable region.

### SUMMARY

Devices, methods, and non-transitory computer readable media are disclosed herein to correct for unwanted rotation in an embedded camera module of an electronic device during field use. Various rotation calibration techniques are disclosed herein, including: a reference pixel pattern-based rotation calibration process; a magnetic field sensor-based rotation calibration process; and a gimbal lock-based rotation calibration process. In some embodiments, an initial rotation calibration angle for the camera module may be obtained during factory calibration and used by the electronic device's image signal processing (ISP) pipeline, so that all captured images are automatically rotation-corrected to compensate for any such rotation measured during factory calibration. In some embodiments, a rotation correction operation may be triggered in response to the electronic device detecting a reliability event (e.g., shock, fall, repair) during field use, which rotation correction operation may be used to update or overwrite the initial rotation calibration angle for the camera module.

In one embodiment, an electronic device is disclosed, comprising: a memory; a first image capture device; a first display; a first positional sensor; and one or more processors operatively coupled to the memory, wherein the one or more processors are configured to execute instructions causing the one or more processors to: obtain a first image captured by the first image capture device, wherein the first image comprises a representation of a reference pixel pattern, and wherein the reference pixel pattern is displayed on a second display of a second electronic device in proximity to the first image capture device; obtain first positional information from the first positional sensor corresponding to a moment the first image was captured; obtain second positional information from a second positional sensor of the second electronic device corresponding to the moment the first image was captured; determine a spatial relationship between the first display and the second display based, at least in part, on the first positional information and the second positional information; and calculate a rotation calibration angle for the first image capture device based, at least in part, on: the determined spatial relationship; the reference pixel pattern; and the representation of the reference pixel pattern captured in the first image.

If desired, the calculated rotation calibration angle may then be utilized (e.g., updated) in an image signal processing pipeline of the electronic device, so that subsequent image processing corrects for the rotation of the camera as measured in field use. In some embodiments, the capture of the first image by the first image capture device may be initiated in response to the first positional sensor detecting a reliability event (e.g., a fall, tilt, shock, vibration, disassembly, repair, etc.) at the electronic device, i.e., an event that may affect or change the accuracy of the factory calibration of an image capture device's rotation.

In some embodiments, the spatial relationship between the first display and the second display may comprise an estimate of a distance between the first display and the second display, e.g., as measured using at least one of: an autofocus (AF) system of the first image capture device; a LIDAR sensor of the electronic device; a Time of Flight (ToF) sensor of the electronic device; a Bluetooth (BT) signal emitted from the electronic device; or an Ultra-wideband (UWB) signal emitted from the electronic device.

In some embodiments, calculating the rotation calibration angle for the first image capture device further comprises measuring an angle of rotation between the reference pixel pattern and the representation of the reference pixel pattern captured in the first image. In some embodiments, the first positional sensor may comprise one or more of: an accelerometer, a gyroscope, or an inertial measurement unit (IMU).

In another embodiment, an electronic device is disclosed, comprising: a memory; a first image capture device; a first magnet external to the first image capture device; a first magnetic field sensor; and one or more processors operatively coupled to the memory, wherein the one or more processors are configured to execute instructions causing the one or more processors to: measure a baseline magnetic field strength at the first magnetic field sensor, wherein the baseline magnetic field strength measurement is configured to measure a magnetic field caused by the first magnet during calibration of the electronic device; measure an operational magnetic field strength at the first magnetic field sensor, wherein the operational magnetic field strength measurement is configured to measure a magnetic field caused by the first magnet during operation of the electronic device; and calculate a rotation calibration angle for the first image capture device based, at least in part, on a difference between the baseline magnetic field strength and the operational magnetic field strength.

If desired, the calculated rotation calibration angle may then be utilized (e.g., updated) in an image signal processing pipeline of the electronic device, so that subsequent image processing corrects for the rotation of the camera as measured in field use. In some embodiments, the measurement of an operational magnetic field strength at the first magnetic field sensor may be initiated in response to detecting a reliability event at the electronic device.

In some embodiments, a relationship may be established for the electronic device, e.g., as between a number of degrees of rotation of the first image capture device and a corresponding amount of change in magnetic flux density measured at the first magnetic field sensor. This established relationship between a number of degrees of rotation of the first image capture device and a corresponding amount of change in magnetic flux density measured at the first magnetic field sensor may then be stored in the memory of the electronic device prior to use, e.g., prior to its use in the field.

In some embodiments, the first magnetic field sensor may comprise at least one of: a Hall effect sensor (e.g., a Bipolar Hall effect sensor), a magnetoresistive sensor (e.g., an anisotropic magnetoresistance (AMR) sensor; a giant magnetoresistance (GMR) sensor; or a tunneling Magnetoresistance (TMR) sensor), or other type of magnetic angle sensor.

In yet another embodiment, an electronic device is disclosed, comprising: a memory; a first image capture device; a first positional sensor in contact with the first image capture device; a first position controller in communication with the first image capture device; a second positional sensor embedded in the electronic device; and one or more processors operatively coupled to the memory, wherein the one or more processors are configured to execute instructions causing the one or more processors to: determine a reference position for the first image capture device relative to the electronic device based, at least in part, on information obtained from the first positional sensor and the second positional sensor during calibration of the electronic device; measure an operational position for the first image capture device relative to the reference position based, at least in part, on information obtained from the first positional sensor during operation of the electronic device; calculate a rotation correction operation for the first image capture device based, at least in part, on a difference between the reference position and the operational position; and cause the first position controller to apply the calculated rotation correction operation to the first image capture device.

In some embodiments, the first positional sensor comprises one or more of: an accelerometer, a gyroscope, or an IMU. In some embodiments, the first position controller may comprise a gimbal system (e.g., a 2-axis gimbal system), that comprises at least an actuator and a velocity controller to control the movement and direction of the gimbal system to reposition/correct the in-field measured rotation of the first image capture device.

Various non-transitory computer readable media embodiments are disclosed herein. Such computer readable media are readable by one or more processors. Instructions may be stored on the computer readable media for causing the one or more processors to perform any of the techniques disclosed herein. Various methods are also disclosed herein, in accordance with the various embodiments enumerated above.

### BRIEF DESCRIPTION OF THE DRAWINGS

FIG. 1 illustrates examples of device reliability events, according to one or more embodiments.

FIG. 2 illustrates an exemplary reference pixel pattern-based rotation calibration process, according to one or more embodiments.

FIG. 3 is a flow chart illustrating an exemplary method of performing a reference pixel pattern-based rotation calibration process, according to one or more embodiments.

FIG. 4 illustrates an exemplary magnetic field sensor-based rotation calibration process, according to one or more embodiments.

FIG. 5 is a flow chart illustrating an exemplary method of performing a magnetic field sensor-based rotation calibration process, according to one or more embodiments.

FIG. 6 illustrates an exemplary gimbal lock-based rotation calibration process, according to one or more embodiments.

FIG. 7 is a flow chart illustrating an exemplary method of performing a gimbal lock-based rotation calibration process, according to one or more embodiments.

FIG. 8 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

### Introduction and Problem Background

As described above, due to assembly tolerances, camera modules installed in electronic devices may end up experiencing undesirable rotation relative to the electronic devices that they are installed in. While various rotation calibration techniques may be applied to correct for such undesirable rotation during factory calibration processes, the electronic device may later, e.g., when in field use by a user, be subject to other reliability events (e.g., shocks, falls, repairs, etc.), in addition to general wear and tear and exposure to the elements, which may cause further undesirable rotation (or other displacement) of the camera module, i.e., in addition to what was corrected for during the factory calibration process. As such, presented herein are novel techniques for performing camera module rotation calibration and correction in electronic devices is the field-preferably with no (or, at least, limited) human interaction.

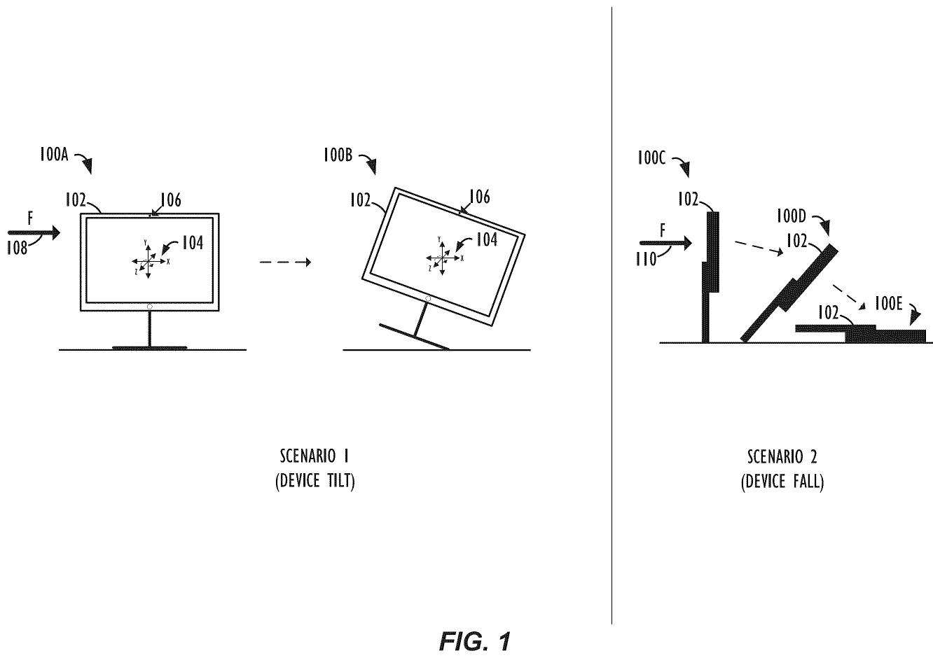

Turning now to FIG. 1, various exemplary device reliability events are illustrated, according to one or more embodiments. In device tilt scenario 100A/B, there is an external force (F) 108 applied the left side of an electronic display device 102 having an embedded image capture device 106 at position 100A. In response to the external force 108, the electronic display device 102 becomes tilted over into position 100B. Depending on the magnitude of the external force 108, how far the electronic display device 102 tilts, and/or whether electronic display device 102 makes contact with another hard surface, e.g., a tabletop or the floor, the embedded image capture device 106 may end up rotating or tilting further in the field (i.e., in addition to any rotation or tilt that was measured in embedded image capture device 106 during factory calibration). Thus, as described above, it would be desirable to detect such a reliability event and then automatically initiate (or present an indication to a user with a request to initiate) an in-field rotation calibration process to correct for any further rotation or tilting the image capture device 106 may have experienced as a result of the recently-experienced device tilt reliability event.

In device fall scenario 100C/D/E, there is an external force (F) 110 applied to the back surface of an electronic display device 102 having an embedded image capture device 106 at position 100C. In response to the external force 110, the electronic display device 102 falls over onto the display screen surface, passing through positions 100D and 100E. Depending on the magnitude of the external force 110, how far the electronic display device 102 falls, and/or whether electronic display device 102 makes contact with another hard surface, e.g., a tabletop or the floor, the embedded image capture device 106 may end up rotating or tilting further in the field (i.e., in addition to any rotation or tilt that was measured in embedded image capture device 106 during factory calibration). Thus, as described above, it would be desirable to detect such a reliability event and then automatically initiate (or present an indication to a user with a request to initiate) an in-field rotation calibration process to correct for any further rotation or tilting the image capture device 106 may have experienced as a result of the recently experienced device fall reliability event.

It is to be understood that many other potential device reliability events exist, which may or may not trigger the electronic device to automatically initiate (or present an indication to a user with a request to initiate) an in-field rotation calibration process. In some cases, in-field rotation calibration process may be initiated after a certain length of device usage, whether or not a reliability event has been detected. In still other cases, in-field rotation calibration process may be initiated manually by a user, e.g., if they begin to see that captured images from an embedded camera modules are noticeably rotated, for any reason.

Exemplary Reference Pixel Pattern-Based Rotation Calibration Process

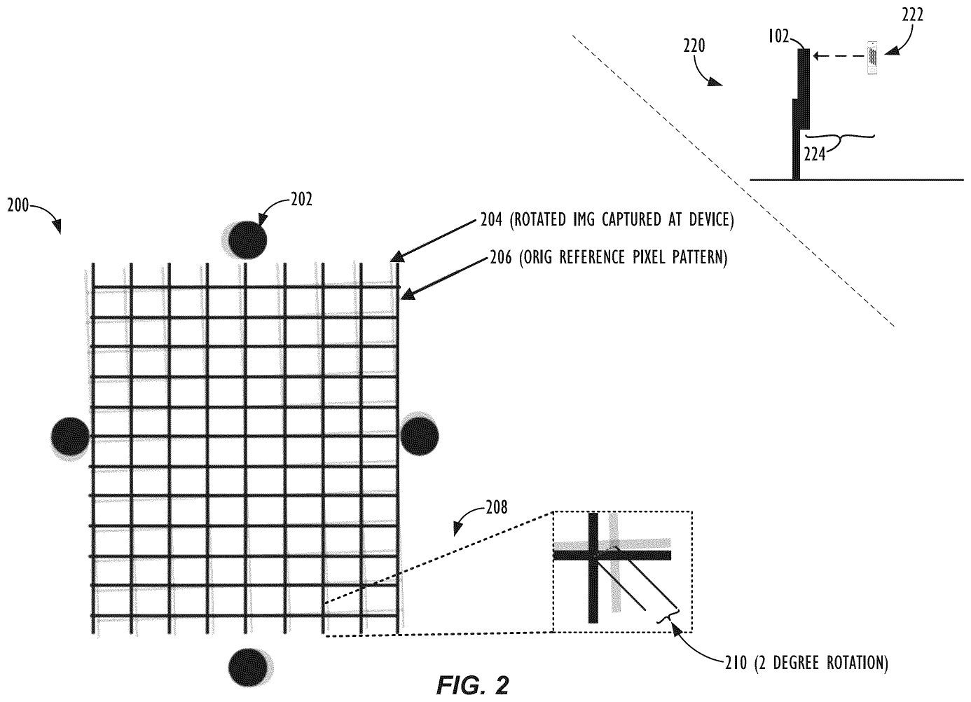

Turning now to FIG. 2, an exemplary reference pixel pattern-based rotation calibration process 200 is shown, according to one or more embodiments. As mentioned above, according to some embodiments, when an electronic device is powered on and detects (e.g., through the use of an accelerometer, gyroscope, IMU, or the like) that the electronic device has sustained a significant reliability event, it may automatically initiate (or trigger a human interface warning regarding the need to perform) a rotation calibration operation.

In the example of FIG. 2, a so-called reference pixel pattern-based rotation calibration process is illustrated. The reference pixel pattern may comprise a simple grid pixel pattern (206), as is shown in FIG. 2, or any other desired pixel pattern or partwork that the electronic device could use to measure a rotation calibration angle. As shown in inset 220, in some embodiments, a display of a second electronic device 222, e.g., a mobile device, may be used to display the reference pixel pattern 206, which may then be captured, e.g., by a first image capture device of an electronic device 102, e.g., a desktop computer with a display. The reference pixel pattern 206 and the first image capture device of an electronic device 102 may be positioned at a known (or measurable) distance from each other 224, and with a known (or measurable) spatial relationship (e.g., relative viewing angle) between their respective displays. As mentioned above, distance 224 may be determined by using an autofocus (AF) system of the first image capture device (e.g., by displaying a reference pixel pattern of a known size on the screen of the second electronic device, an image capture device of the electronic device may be able to use an autofocus position sensing function, which can utilize the thin lens equation, in conjunction with knowing its focal length and the physical distance of the second electronic device's camera lens to the image capture device's image sensor, to determine a distance to the displayed reference pixel pattern); a LIDAR sensor of the electronic device; a Time of Flight (ToF) sensor of the electronic device; a Bluetooth (BT) signal emitted from the electronic device; or an Ultra-wideband (UWB) signal emitted from the electronic device.

In some embodiments, it may also be desirable for the display of a second electronic device 222 to be parallel to the display of electronic device 102, thus removing any sort of measurement offsets when comparing the displayed reference pixel pattern against the image captured at the electronic device 102. Achieving a perfect (e.g., parallel) alignment between devices 102 and 222 during the rotation calibration process may also eliminate any biases within the six degrees of freedom (i.e., x, y, z, yaw, pitch, and roll). (This process assumes a known relationship between the positional sensor, e.g., an IMU, of each electronic device 102/222 and its own display that will be used to display the reference pixel pattern. Having this known relationship allows the calibration process to cancel out any tilt or rotation biases between the displays of the devices, such that the only remaining delta is due to any unwanted rotation of the image capture device of the electronic device 102.)

Then, processes executing on the electronic device 102 may compute any rotation calibration angle delta between the original reference pixel pattern 206 and the rotated image of the reference pixel pattern 204, as captured at the electronic device 102 during the reference pixel pattern-based rotation calibration process. Finally, the electronic device 102 may apply and/or store the determined rotation calibration angle in memory, so that it may be used to correct subsequent images captured by the first image capture device of an electronic device 102.

As illustrated in blowout box 208 of FIG. 2, there is a measured 2-degree rotation calibration angle (210) between the original reference pixel pattern 206 and the captured image of the reference pixel pattern 204, indicating that there has been a further in-field rotation of 2 degrees counterclockwise of the first image capture device of an electronic device 102. As may now be appreciated, if an equal and opposite clockwise rotation of 2 degrees clockwise is applied to subsequent images captured by the first image capture device of an electronic device 102, the unwanted in-field rotation will be removed from such subsequent captured images.

In the example shown in FIG. 2, the original reference pixel pattern 206 comprises four fiducial points (202) that may be used to guide the alignment operation, and each grid intersection point represents a coordinate that may be compared in the captured image of the reference pixel pattern 204 against its respective position in the original reference pixel pattern 206. As may now be understood, by comparing the pre- and post-alignment intersection coordinates, cartesian angles of the vectors from each coordinate may be calculated to compute the overall rotation calibration angle, which, in this case, was 2 degrees. As may now be appreciated, the distance 224 may also be used in the deriving the overall rotation angle from the shift in coordinate points between the reference pixel pattern and the captured image, e.g., to eliminate any distance biases during the rotation calibration.

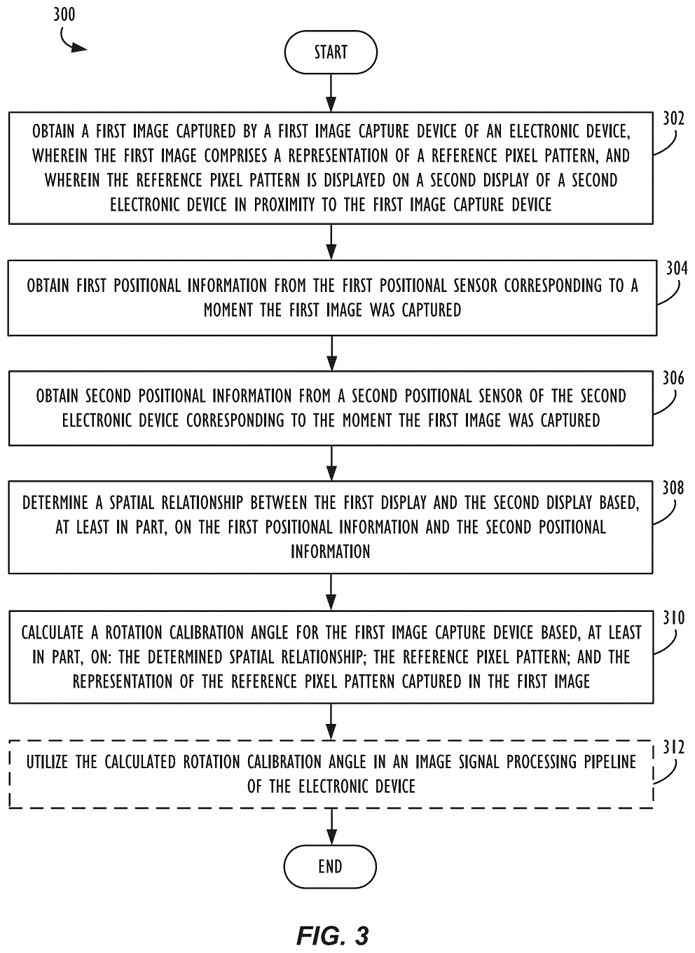

Turning now to FIG. 3, a flow chart illustrating an exemplary method 300 of performing a reference pixel pattern-based rotation calibration process is shown, according to one or more embodiments. First, at Step 302, the method 300 may obtain a first image captured by a first image capture device of an electronic device, wherein the first image comprises a representation of a reference pixel pattern, and wherein the reference pixel pattern is displayed on a second display of a second electronic device in proximity to the first image capture device. Next, at Step 304, the method 300 may obtain first positional information from the first positional sensor corresponding to a moment the first image was captured and, at Step 306, obtain second positional information from a second positional sensor of the second electronic device corresponding to the moment the first image was captured.

Next, at Step 308, the method 300 may determine a spatial relationship (e.g., a distance and/or relative orientation between the first display and second display) between the first display and the second display based, at least in part, on the first positional information and the second positional information. In some embodiments, Step 308 may comprise a recurring closed-loop feedback system that continues to determine a spatial relationship between the first display and the second display until a desired spatial relationship is achieved (e.g., the second display being held parallel to the first display, and at a desired height). In some such embodiments, feedback may be given to the user positioning the second electronic device (e.g., audio, visual, haptic, etc.), in order to assist the user in positioning the second electronic device quickly in the desired spatial relationship with respect to the electronic device. Next, at Step 310, the method 300 may calculate a rotation calibration angle for the first image capture device based, at least in part, on: the determined spatial relationship; the reference pixel pattern; and the representation of the reference pixel pattern captured in the first image. Finally, at Step 312, the method 300 may optionally utilize the calculated rotation calibration angle in an image signal processing pipeline of the electronic device.

Exemplary Magnetic Field Sensor-Based Rotation Calibration Process

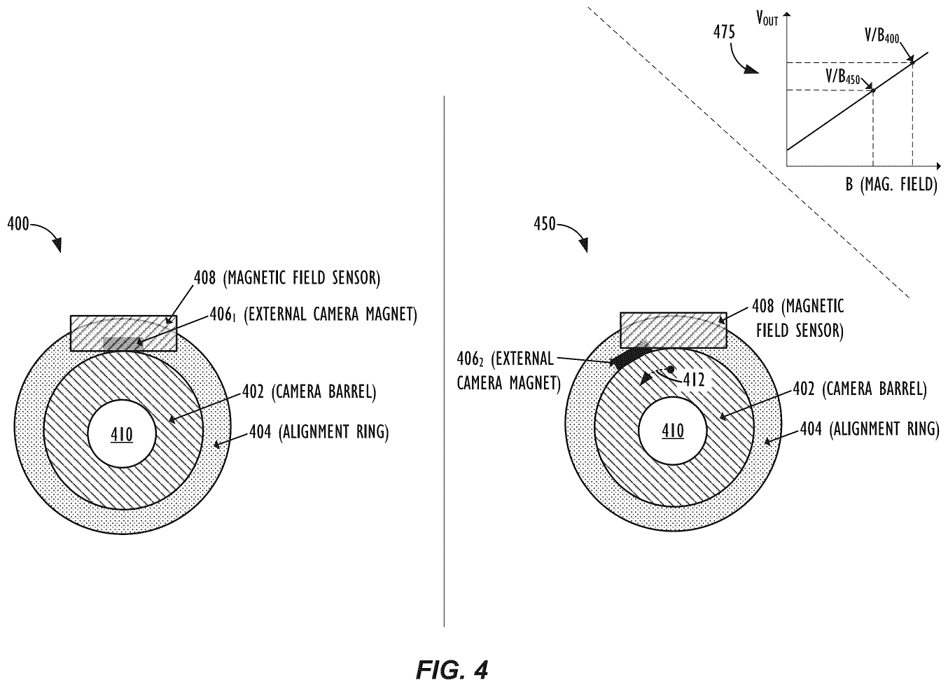

Turning now to FIG. 4, an exemplary magnetic field sensor-based rotation calibration process 400/450 is shown, according to one or more embodiments. Device state 400 represents an exemplary default design state for an image capture device embedded in another electronic device. For example, cross-hatched region 402 represents the barrel of a camera of an image capture device, which also includes a lens region 410. According to some embodiments, the camera may be held in place relative to the electronic device that it is embedded in via an alignment ring 404.

According to various magnetic field sensor-based rotation calibration processes described herein, the alignment ring 404 may further comprise an external camera magnet 406, which is shown at a default position 406₁ in device state 400. At default position 406₁, a magnetic field sensor 408 may be used to measure a baseline magnetic flux density, which may be measured, e.g., in terms of a voltage that is measured at magnetic field sensor 408. In some embodiments, magnetic field sensors, such as Bipolar Hall effect sensors, can be used in such a calibration process, which sensors are able to respond to both positive and negative changes in magnetic fields. Since the unwanted rotation of the camera module can be in either a positive (e.g., the external camera magnet becoming better aligned with the magnetic field sensor) or negative direction (e.g., the external camera magnet becoming less aligned with the magnetic field sensor), the use of a Bipolar sensor may be preferred in some embodiments. In other embodiments, the first magnetic field sensor may comprise at least one of: a magnetoresistive sensor (e.g., an anisotropic magnetoresistance (AMR) sensor; a giant magnetoresistance (GMR) sensor; or a tunneling Magnetoresistance (TMR) sensor), or other type of magnetic angle sensor. In either case, the magnetic field strength (B) may be proportional to the Voltage out (Vₒᵤₜ) measured at the magnetic field sensor.

In some embodiments, a relationship may be established for the electronic device, e.g., as between a number of degrees of rotation of the first image capture device and a corresponding amount of change in magnetic flux density measured at the first magnetic field sensor (e.g., in terms of μT per degree of rotation). This established relationship between a number of degrees of rotation of the first image capture device and a corresponding amount of change in magnetic flux density measured at the first magnetic field sensor may then be stored in the memory of the electronic device prior to use, e.g., prior to its use in the field, used to dynamically correct for any unwanted camera module rotation that occurs in-field.

Device state 450 represents an exemplary rotated design state, wherein the image capture device (e.g., camera 402) that was embedded in the electronic device has rotated (as indicated by arrow 412) during in-field usage, which has caused the external camera magnet 406 to become rotated to position 406₂ in device state 450. As may now be understood, this rotation will cause magnetic field sensor 408 to measure an operational magnetic flux density that will be different than a baseline magnetic flux density that would be measured, e.g., with the external camera magnet 406 in the default position 406₁. Using the aforementioned established relationship, the change in magnetic flux density (or, by proxy, output voltage) may easily and accurately be converted into a number of degrees of rotation (including, possibly, the direction of such rotation, too). Depending on embodiment, changes in magnetic flux density may be measured for continuously, at predetermined intervals, in response to the detection of particular events (e.g., reliability events), and/or in response to a user indicating an affirmative desire to perform a rotation calibration operation.

As shown in inset 475, in some embodiments, the established relationship between magnetic field strength and measured output voltage at the magnetic field sensor may be plotted and/or extrapolated into a function, e.g., a linear function. As shown in inset 475, the rotation of the external camera magnet 406 in this example from default position 406₁ to rotated position 406₂ has caused the measured voltage (and, by extensions, magnetic field strength) at the magnetic field sensor 408 to shift from position V/B₄₀₀ to position V/B₄₅₀ on the linear function. As mentioned above, this change in measured magnetic field strength may be converted to the degrees of rotation that the camera has experienced (e.g., via the aforementioned established relationship) and then, an additional rotation calibration angle may be applied to the electronic device's image signal processing pipeline going forward. In some embodiments, a counterclockwise rotation of the camera module may be defined as an output voltage getting lower, while a clockwise rotation may be defined as an output voltage getting higher. In other embodiments, however, that sign convention for rotation may be reversed, if desired.

In some embodiments, one or more additional magnetic field sensors coupled with one or more additional external camera magnets may also be installed at determined locations in the camera module of the electronic device in order to eliminate external magnetic field noise that may be present in the electronic device. By eliminating external magnetic field noise, more accurate readings may be obtained by magnetic field sensor 408. Eliminating external fields may be important in some situations, as they can cause an erroneous voltage value to be captured, e.g., causing the calibration value to be large and false. For example, if a rotation calibration process is being performed and there happens to be a strong permanent magnet to the camera area while the calibration process is being performed, it may be desirable to either cancel out the external magnetic field and/or fail the current calibration process and inform the user about the presence of the significant external magnetic field in the vicinity of the camera module.

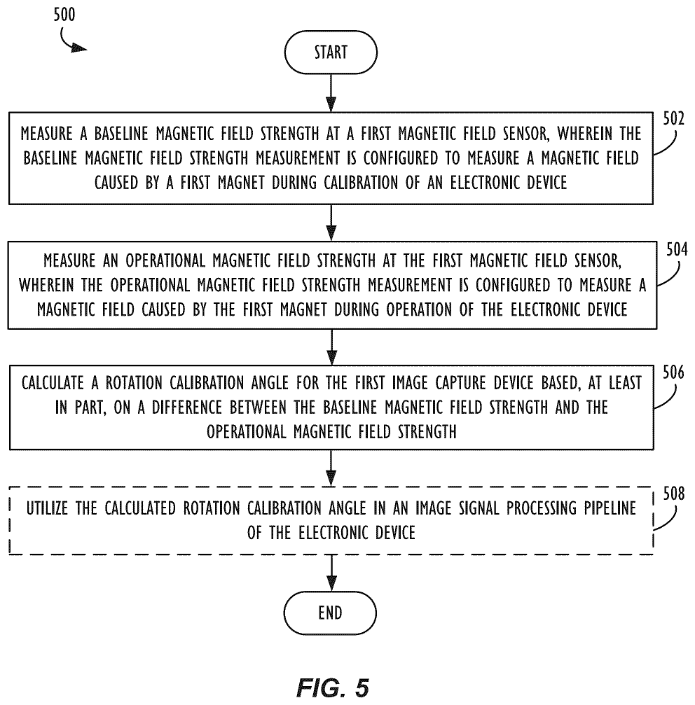

Turning now to FIG. 5, a flow chart illustrating an exemplary method 500 of performing a magnetic field sensor-based rotation calibration process is shown, according to one or more embodiments. First, at Step 502, the method 500 may measure a baseline magnetic field strength at a first magnetic field sensor, wherein the baseline magnetic field strength measurement is configured to measure a magnetic field caused by a first magnet during calibration of an electronic device. Next, at Step 504, the method 500 may measure an operational magnetic field strength at the first magnetic field sensor, wherein the operational magnetic field strength measurement is configured to measure a magnetic field caused by the first magnet during operation of the electronic device. Next, at Step 506, the method 500 may calculate a rotation calibration angle for the first image capture device based, at least in part, on a difference between the baseline magnetic field strength and the operational magnetic field strength. Finally, at Step 508, the method 500 may optionally utilize the calculated rotation calibration angle in an image signal processing pipeline of the electronic device.

Exemplary Gimbal Lock-Based Rotation Calibration Process

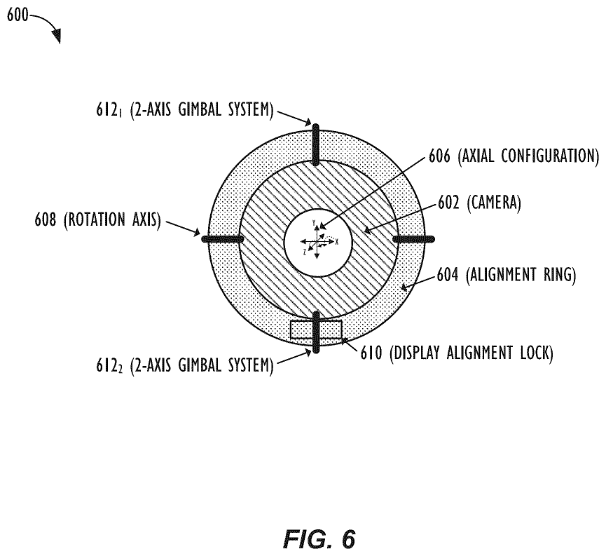

Turning now to FIG. 6, an exemplary gimbal lock-based rotation calibration process 600 is shown, according to one or more embodiments. As described above with regard to FIG. 4, region 602 represents the barrel of a camera of an image capture device. According to some embodiments, the camera may be held in place relative to the electronic device that it is embedded in via an alignment ring 604.

In some gimbal lock-based rotation calibration embodiments, a 2-axis gimbal system (612₁/612₂) may be installed around the camera and serve as a position controller for the camera during the rotation calibration process. In some embodiments, the camera may be re-positioned around one or more axes of rotation 608. For example, in some embodiments, the only available axial movements for the gimbal system to re-position the camera device may be the roll (e.g., z-axis) and pitch (e.g., x-axis), as shown by the dashed arrows around the x- and z-axes in exemplary axial configuration 606. In other words, repositioning of the camera device around the yaw axis may not be needed, e.g., due to a tight camera-to-display assembly tolerance that is able to completely restrict movement of the camera module about the yaw axis, e.g., via a display alignment lock, such as display alignment lock 610. Display alignment lock 610 may comprise a cowling or other type of mechanical locking mechanism to secure the back of the camera 602 to the display alignment ring 604 during assembly of the electronic device. If assembly tolerances are further tightened in a given manufacturing process, it may be that only a single axis of rotation (e.g., roll) is required during the rotation calibration process. Human perception is also most sensitive to rotation about the roll-axis, so, in some cases, it may be the most essential rotation axis to correct about, e.g., if only a limited number of axes of rotation may be corrected for in a given embodiment. In still other implementations, if desired, a 3-axis gimbal system may also be installed, i.e., a system that is able to re-position the camera in each of the roll, pitch, and yaw axes. In cases where this display alignment lock 610 fails during field use, e.g., having a 3-axis gimbal system that is able to rotate and re-position the camera module in the yaw direction would be able to be used to correct for any rotation of the camera module in the yaw direction, e.g., due to the failed alignment lock.

By using positional sensor measurements (e.g., from one or more of an IMU, accelerometer, or gyroscope), the gimbal system will be able to apply the appropriate correction rotation in the roll and/or pitch directions to ensure the camera module remains centered during in-field use, i.e., with zero degrees of rotation. For example, in some embodiments, the electronic device may utilize two or more distinct positional sensors in the rotation calibration process, i.e., one (or more) embedded on the camera module (e.g., on the camera barrel) and another one (or more) embedded near the camera module (e.g., within a bezel of the display of the electronic device). It is to be understood that some gimbal systems may have a separate IMU (with one or more internal gyroscopes) for each axial movement direction, e.g., an individual IMU may comprise three orthogonally-mounted gyroscopes. Further, including one or more additional positional sensors within the electronic device (e.g., within the display and/or on the camera module itself) may help the calibration system to be able to reject any external rotation noise to improve the accuracy of the image capture device rotation calibration process.

These positional sensors may then feed information into a recurring feedback loop that is configured to calculate any deltas between the two positional sensors (i.e., to determine whether the camera module has rotated with respect to the frame of reference of the bezel of the display of the electronic device itself). If such a delta is determined to exist, then a velocity controller may be configured to determine how much velocity to turn the gimbal lock system, and then use one or more actuators to rotation each respective axis of the gimbal by the appropriate amount to return the camera module to having zero degrees of rotation with respect to the frame of reference of the bezel of the display of the electronic device. Once the feedback loop is registering zero degrees of rotation again, the gimbal lock system may again lock the camera module in place until another unwanted rotation in the camera module is detected.

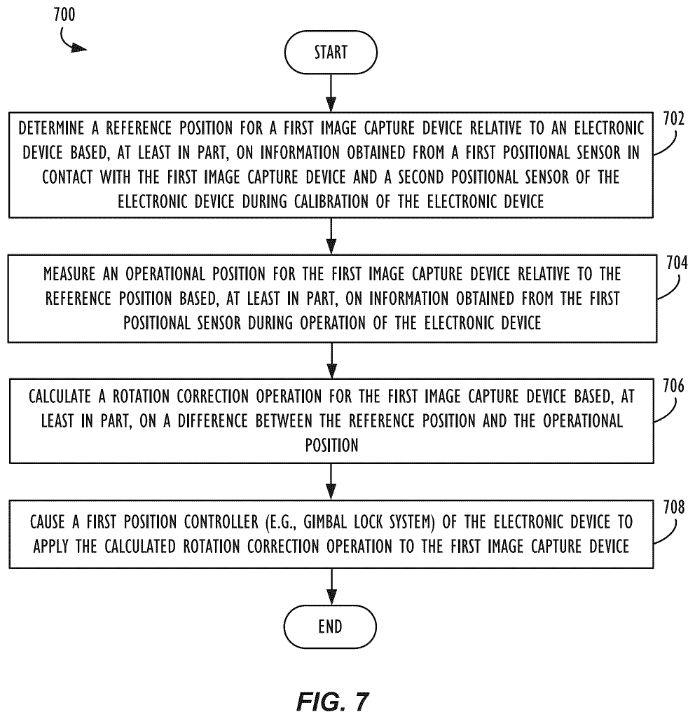

Turning now to FIG. 7, a flow chart illustrating an exemplary method 700 of performing a gimbal lock-based rotation calibration process is shown, according to one or more embodiments. First, at Step 702, the method 500 may determine a reference position for a first image capture device relative to an electronic device based, at least in part, on information obtained from a first positional sensor in contact with the first image capture device and a second positional sensor of the electronic device during calibration of the electronic device. Next, at Step 704, the method 700 may measure an operational position for the first image capture device relative to the reference position based, at least in part, on information obtained from the first positional sensor during operation of the electronic device. Next, at Step 706, the method 700 may calculate a rotation correction operation for the first image capture device based, at least in part, on a difference between the reference position and the operational position. Finally, at Step 708, the method 700 may cause a first position controller (e.g., a gimbal lock system, such as two-axis gimbal lock system) of the electronic device to apply the calculated rotation correction operation to the first image capture device, thereby bringing the first image capture device back into its reference position and/or a zero-degree rotation position with respect to the electronic device.

Exemplary Electronic Computing Devices

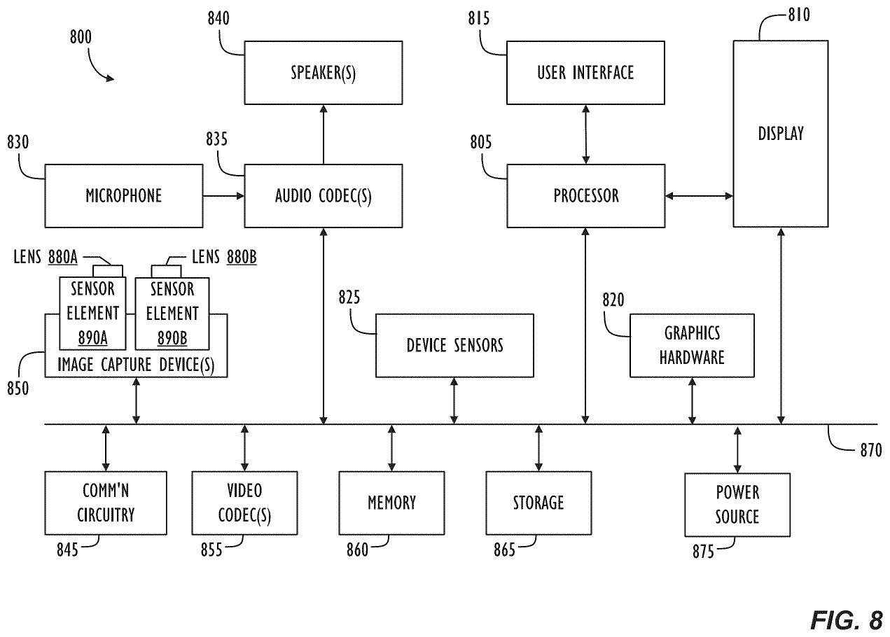

Referring now to FIG. 8, a simplified functional block diagram of illustrative programmable electronic computing device 800 is shown according to one embodiment. Electronic device 800 could be, for example, a mobile telephone, personal media device, portable camera, or a tablet, notebook or desktop computer system. As shown, electronic device 800 may include processor 805, display 810, user interface 815, graphics hardware 820, device sensors 825 (e.g., proximity sensor/ambient light sensor, accelerometer, inertial measurement unit, and/or gyroscope), microphone 830, audio codec(s) 835, speaker(s) 840, communications circuitry 845, image capture device(s) 850, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 855, memory 860, storage 865, and communications bus 880.

Processor 805 may execute instructions necessary to carry out or control the operation of many functions performed by electronic device 800 (e.g., such as the generation and/or processing of images in accordance with the various embodiments described herein). Processor 805 may, for instance, drive display 810 and receive user input from user interface 815. User interface 815 can take a variety of forms, such as a button, keypad, dial, a click wheel, keyboard, display screen and/or a touch screen. User interface 815 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 810 may display a video stream as it is captured while processor 805 and/or graphics hardware 820 and/or image capture circuitry contemporaneously generate and store the video stream in memory 860 and/or storage 865. Processor 805 may be a system-on-chip (SOC) such as those found in mobile devices and include one or more dedicated graphics processing units (GPUs). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 perform computational tasks. In one embodiment, graphics hardware 820 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 850 may comprise one or more camera units configured to capture images, e.g., images which may be processed to help further calibrate said image capture device in field use, e.g., in accordance with this disclosure. Image capture device(s) 850 may include two (or more) lens assemblies 880A and 880B, where each lens assembly may have a separate focal length. For example, lens assembly 880A may have a shorter focal length relative to the focal length of lens assembly 880B. Each lens assembly may have a separate associated sensor element, e.g., sensor elements 890A/890B. Alternatively, two or more lens assemblies may share a common sensor element. Image capture device(s) 850 may capture still and/or video images. Output from image capture device(s) 850 may be processed, at least in part, by video codec(s) 855 and/or processor 805 and/or graphics hardware 820, and/or a dedicated image processing unit or image signal processor incorporated within image capture device(s) 850. Images so captured may be stored in memory 860 and/or storage 865. As mentioned with reference to the various embodiments disclosed above, image capture device(s) 850 may be positioned in contact with (or in close proximity to) one or more magnetic field sensors, external magnets, and or position controller systems (e.g., a gimbal lock system) that may be utilized during an in-field rotation calibration process.

Memory 860 may include one or more different types of media used by processor 805, graphics hardware 820, and image capture device(s) 850 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to retain computer program instructions or code organized into one or more modules and written in any desired computer programming language. When executed by, for example, processor 805, such computer program code may implement one or more of the methods or processes described herein. Power source 875 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 800.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. An electronic device, comprising:
a memory;
a first image capture device;
a first display;
a first positional sensor; and
one or more processors operatively coupled to the memory, wherein the one or more processors are configured to execute instructions causing the one or more processors to:
obtain a first image captured by the first image capture device, wherein the first image comprises a representation of a reference pixel pattern, and wherein the reference pixel pattern is displayed on a second display of a second electronic device in proximity to the first image capture device;
obtain first positional information from the first positional sensor corresponding to a moment the first image was captured;
obtain second positional information from a second positional sensor of the second electronic device corresponding to the moment the first image was captured;
determine a spatial relationship between the first display and the second display based, at least in part, on the first positional information and the second positional information; and
calculate a rotation calibration angle for the first image capture device based, at least in part, on: the determined spatial relationship; the reference pixel pattern; and the representation of the reference pixel pattern captured in the first image.

2. The electronic device of claim 1, wherein the instructions to determine a spatial relationship between the first display and the second display further comprise instructions to cause the one or more processors to:
estimate a distance between the first display and the second display.

3. The electronic device of claim 2, wherein the instructions to cause the one or more processors to estimate a distance between the first display and the second display further comprise instructions to cause the one or more processors to estimate a distance between the first display and the second display using at least one of:
an autofocus (AF) system of the first image capture device;
a LIDAR sensor of the electronic device;
a Time of Flight (ToF) sensor of the electronic device;
a Bluetooth (BT) signal emitted from the electronic device; or
an Ultra-wideband (UWB) signal emitted from the electronic device.

4. The electronic device of claim 1, wherein the instructions to calculate a rotation calibration angle for the first image capture device further comprise instructions to cause the one or more processors to:
measure an angle of rotation between the reference pixel pattern and the representation of the reference pixel pattern captured in the first image.

5. The electronic device of claim 1, further comprising instructions to cause the one or more processors to:
utilize the calculated rotation calibration angle in an image signal processing pipeline of the electronic device.

6. The electronic device of claim 1, wherein the first positional sensor comprises one or more of: an accelerometer, a gyroscope, or an inertial measurement unit (IMU).

7. The electronic device of claim 1, further comprising instructions to cause the one or more processors to:
initiate the capture of the first image by the first image capture device in response to the first positional sensor detecting a reliability event at the electronic device.

8. An electronic device, comprising:
a memory;
a first image capture device;
a first magnet external to the first image capture device;
a first magnetic field sensor; and
one or more processors operatively coupled to the memory, wherein the one or more processors are configured to execute instructions causing the one or more processors to:
measure a baseline magnetic field strength at the first magnetic field sensor, wherein the baseline magnetic field strength measurement is configured to measure a magnetic field caused by the first magnet during calibration of the electronic device;
measure an operational magnetic field strength at the first magnetic field sensor, wherein the operational magnetic field strength measurement is configured to measure a magnetic field caused by the first magnet during operation of the electronic device; and
calculate a rotation calibration angle for the first image capture device based, at least in part, on a difference between the baseline magnetic field strength and the operational magnetic field strength.

9. The electronic device of claim 8, wherein the first magnetic field sensor comprises at least one of: a Hall effect sensor, a magnetoresistive sensor, or a magnetic angle sensor.

10. The electronic device of claim 8, wherein the first magnetic field sensor comprises a Bipolar Hall effect sensor.

11. The electronic device of claim 8, wherein the first magnetic field sensor comprises at least one of: an anisotropic magnetoresistance (AMR) sensor; a giant magnetoresistance (GMR) sensor; or a tunneling Magnetoresistance (TMR) sensor.

12. The electronic device of claim 8, further comprising instructions to cause the one or more processors to:
initiate the measurement of an operational magnetic field strength at the first magnetic field sensor in response to detecting a reliability event at the electronic device.

13. The electronic device of claim 8, further comprising instructions to cause the one or more processors to:
establish, for the electronic device, a relationship between a number of degrees of rotation of the first image capture device and a corresponding amount of change in magnetic flux density measured at the first magnetic field sensor.

14. The electronic device of claim 13, further comprising instructions to cause the one or more processors to:
store the established relationship between a number of degrees of rotation of the first image capture device and a corresponding amount of change in magnetic flux density measured at the first magnetic field sensor in the memory prior to use of the electronic device.

15. The electronic device of claim 8, further comprising instructions to cause the one or more processors to:
utilize the calculated rotation calibration angle in an image signal processing pipeline of the electronic device.

16. An electronic device, comprising:
a memory;
a first image capture device;
a first positional sensor in contact with the first image capture device;
a first position controller in communication with the first image capture device;
a second positional sensor embedded in the electronic device; and
one or more processors operatively coupled to the memory, wherein the one or more processors are configured to execute instructions causing the one or more processors to:
determine a reference position for the first image capture device relative to the electronic device based, at least in part, on information obtained from the first positional sensor and the second positional sensor during calibration of the electronic device;
measure an operational position for the first image capture device relative to the reference position based, at least in part, on information obtained from the first positional sensor during operation of the electronic device;
calculate a rotation correction operation for the first image capture device based, at least in part, on a difference between the reference position and the operational position; and
cause the first position controller to apply the calculated rotation correction operation to the first image capture device.

17. The electronic device of claim 16, wherein the first positional sensor comprises one or more of: an accelerometer, a gyroscope, or an inertial measurement unit (IMU).

18. The electronic device of claim 16, wherein the first position controller comprises a gimbal system.

19. The electronic device of claim 16, wherein the first position controller comprises an actuator.

20. The electronic device of claim 16, wherein the first position controller comprises a velocity controller.
